(19) United States
(12) Patent Application Publication
(10) Pub. No.: US 2003/0088856 A1
(43) Pub. Date: May 8, 2003

(54) Method and apparatus for obtaining the address of a descriptor

(76) Inventors: Jay P. Hoeflinger, Urbana, IL (US); Sanjiv M. Shah, Champaign, IL (US); David K. Poulsen, Champaign, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/008,691

(22) Filed: Nov. 8, 2001

(51) Int. Cl. G06F 9/45

(52) U.S. Cl. 717/136

(57) ABSTRACT

A method and apparatus for generating source code to return the memory address of a descriptor are described. In an embodiment, the method includes generating a function having an argument. The function is expressed in a high-level programming language. The function includes a set of one or more instructions that instruct a compiler unit to return a memory address of the argument as a result of the function. The method also includes generating a call to the function. The call is expressed in the high-level programming language. The call causes the compiler unit to pass a descriptor as the argument.

### FIELD OF THE INVENTION

The invention relates to code compilation. More specifically, the invention relates to the generation of code to alter the output of a compiler.

### BACKGROUND OF THE INVENTION

The high-level programming language, Fortran90, typically implements a pointer type with a descriptor or a “fat” pointer, which can contain more than just the address to which the pointer is pointing, such as size of the data to which the pointer is pointing. Additionally, Fortran90 can contain intrinsic functions or routines (that can be within run time libraries), which are predefined functions within the language that output a specific result when a given argument is entered. For example, Fortran90 contains the intrinsic function “LOC(x),” which returns the memory address of ‘x.’ However, in certain circumstances, a limitation in these programming languages does not allow for the obtaining of the memory address of a descriptor simply by inputting the descriptor as the argument of the LOC intrinsic function. Inputting a descriptor as the argument of the LOC intrinsic function returns the memory address of the target of the descriptor instead of the memory address of the descriptor.

One such circumstance where this limitation may arise includes when code written in these programming languages utilize a runtime library, which is written in a different programming language, for implementation of various intrinsic functions or routines. For example, source code written in Fortran90 may be required to access a runtime library written in the high-level programming language C. In such an instance, when working with descriptors, it is sometimes necessary to obtain the memory address thereof when accessing the runtime library and returning to the Fortran90 syntax. Other circumstances may also require the memory address of a descriptor. However, current limitations as explained above prevent such an operation.

### BRIEF DESCRIPTION OF THE DRAWINGS

Embodiments of the invention may be best understood by referring to the following description and accompanying drawings, which illustrate such embodiments. The numbering scheme for the Figures included herein are such that the leading number for a given element in a Figure is associated with the number of the Figure. For example, system 100 can be located in FIG. 1. However, element numbers are the same for those elements that are the same across different Figures.

In the drawings:

FIG. 1 illustrates an exemplary system 100 comprising processors 102 and 104 for obtaining the memory address of a descriptor, according to embodiments of the present invention.

FIG. 2 illustrates a block diagram of the relationship between descriptor 202 and target 210, according to embodiments of the present invention.

FIG. 3 illustrates a data flow diagram for generation of executable code 308, which when executed returns the memory address of a descriptor, according to embodiments of the present invention.

FIG. 4 illustrates a flowchart of one embodiment for the generation of code to determine memory addresses of descriptors, according to embodiments of the present invention.

FIG. 5 illustrates source code that includes a number of descriptors for which the address is being obtained, according to embodiments of the present invention.

FIG. 6 shows a data structure for storage of descriptor information, according to embodiments of the present invention.

FIG. 7 shows source code being generated by translation unit 180, according to embodiments of the present invention.

### DETAILED DESCRIPTION

A method and apparatus for generating source code to return the memory address of a descriptor are described. In the following description, for purposes of explanation, numerous specific details are set forth in order to provide a thorough understanding of the present invention. It will be evident, however, to one skilled in the art that the present invention may be practiced without these specific details. Moreover, embodiments of the present invention are described with reference to the Fortran90 programming language. This is by way of example and not by way of limitation, as embodiments of the present invention can be incorporated into other languages that can be at different levels.

System Description

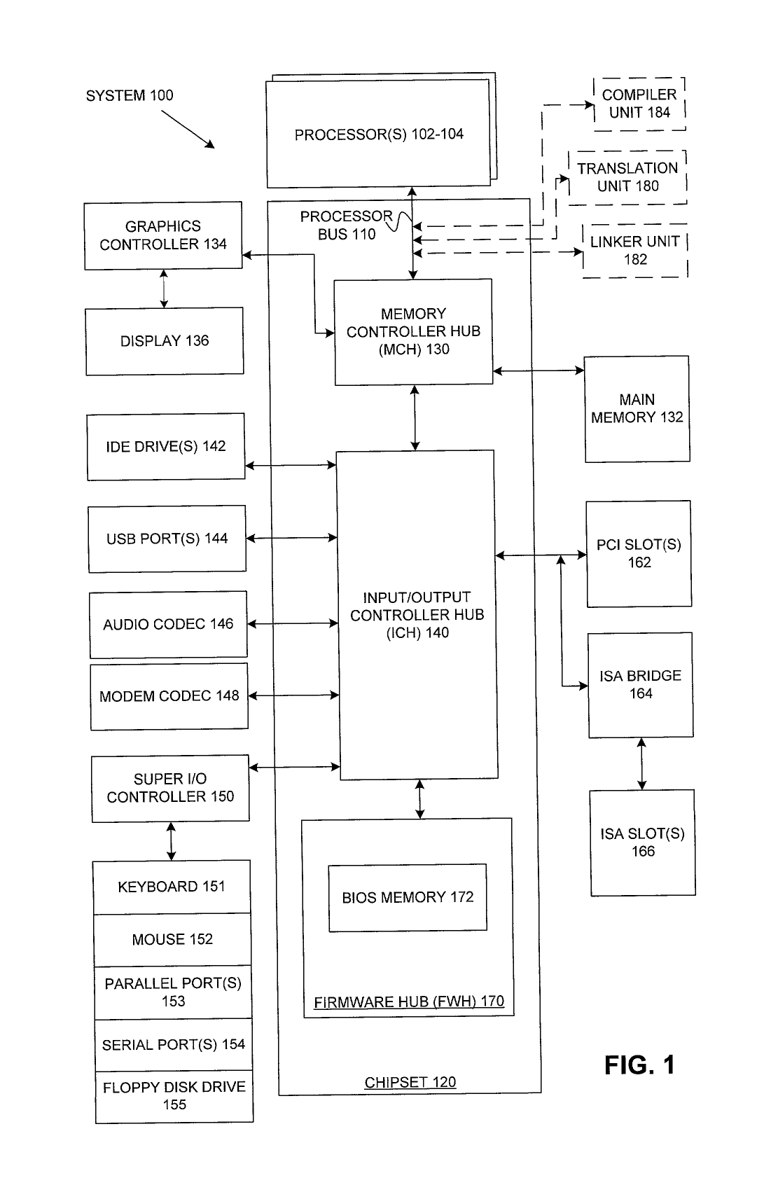

FIG. 1 illustrates an exemplary system 100 comprising processors 102 and 104 for obtaining the memory address of a descriptor, according to embodiments of the present invention. Although described in the context of system 100, the present invention may be implemented in any suitable computer system comprising any suitable one or more integrated circuits.

As illustrated in FIG. 1, computer system 100 comprises processor 102 and processor 104. Computer system 100 also includes processor bus 110 and chipset 120. Processors 102 and 104 and chipset 120 are coupled with processor bus 110. Processors 102 and 104 may each comprise any suitable processor architecture and for one embodiment comprise an Intel® Architecture used, for example, in the Pentium® family of processors available from Intel® Corporation of Santa Clara, Calif. In other embodiments, computer system 100 may comprise one, three, or more processors, any of which may execute a set of instructions that are in accordance with embodiments of the present invention.

Chipset 120 for one embodiment comprises memory controller hub (“MCH”) 130, input/output (“I/O”) controller hub (“ICH”) 140, and firmware hub (“FWH”) 170. MCH 130, ICH 140, and FWH 170 may each comprise any suitable circuitry and for one embodiment is each formed as a separate integrated circuit chip. In other embodiments, chipset 120 may comprise any suitable one or more integrated circuit devices.

MCH 130 may comprise any suitable interface controllers to provide for any suitable communication link to processor bus 110 and/or to any suitable device or component in communication with MCH 130. MCH 130 for one embodiment provides suitable arbitration, buffering, and coherency management for each interface.

MCH 130 is coupled with processor bus 110 and provides an interface to processors 102 and 104 over processor bus 110. Processor 102 and/or processor 104 may alternatively be combined with MCH 130 to form a single chip. In one embodiment, MCH 130 also provides an interface to a main memory 132 and a graphics controller 134 each coupled with MCH 130. Main memory 132 stores data and/or instructions, for example, for computer system 100 and may comprise any suitable memory, for example, a dynamic random access memory (“DRAM”). Graphics controller 134 controls the display of information on a suitable display 136, for example, a cathode ray tube (“CRT”) or liquid crystal display (“LCD”) coupled with graphics controller 134. MCH 130 for one embodiment interfaces with graphics controller 134 through an accelerated graphics port (“AGP”). Graphics controller 134 for one embodiment may alternatively be combined with MCH 130 to form a single chip.

MCH 130 is also coupled with ICH 140 to provide access to ICH 140 through a hub interface. ICH 140 provides an interface to I/O devices or peripheral components for computer system 100. ICH 140 may comprise any suitable interface controllers to provide for any suitable communication link to MCH 130 and/or to any suitable device or component in communication with ICH 140. ICH 140 for one embodiment provides suitable arbitration and buffering for each interface.

For one embodiment, ICH 140 provides an interface to one or more suitable integrated drive electronics (“IDE”) drives 142, for example, a hard disk drive (“HDD”) or compact disc read only memory (“CD ROM”) drive, to store data and/or instructions one or more suitable universal serial bus (“USB”) devices through one or more USB ports 144, an audio coder/decoder (“codec”) 146, or a modem codec 148. In one embodiment, ICH 140 also provides an interface through a super I/O controller 150 to a keyboard 151, a mouse 152, one or more suitable devices, for example, a printer, through one or more parallel ports 153, one or more suitable devices through one or more serial ports 154, and a floppy disk drive 155. ICH 140 for one embodiment further provides an interface to one or more suitable peripheral component interconnect (“PCI”) devices coupled with ICH 140 through one or more PCI slots 162 on a PCI bus and an interface to one or more suitable industry standard architecture (“ISA”) devices coupled to ICH 140 by the PCI bus through an ISA bridge 164. ISA bridge 164 interfaces with one or more ISA devices through one or more ISA slots 166 on an ISA bus.

ICH 140 is also coupled with FWH 170 to provide an interface to FWH 170. FWH 170 may comprise any suitable interface controller to provide for any suitable communication link to ICH 140. FWH 170 for one embodiment may share at least a portion of the interface between ICH 140 and super I/O controller 150. FWH 170 comprises a basic input/output system (“BIOS”) memory 172 to store suitable system and/or video BIOS software. BIOS memory 172 may comprise any suitable non-volatile memory, for example, a flash memory.

Additionally, computer system 100 includes translation unit 180, linker unit 182, and compiler unit 184, which are shown with dashed lines. In an embodiment, translation unit 180, linker unit 182, and compiler unit 184 can be processes or tasks that can reside within main memory 132 and/or processors 102 and 104 and can be executed within processors 102 and 104. However, embodiments of the present invention are not so limited, as translation unit 180, linker unit 182, and compiler unit 184 can be different types of hardware (such as digital logic) or software executing the processing described therein (which is described in more detail below).

Accordingly, computer system 100 includes a machine-readable medium on which is stored a set of instructions (i.e., software) embodying any one, or all, of the methodologies described above. For example, software can reside, completely or at least partially, within main memory 132 and/or within processors 102 and 104. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, and electrical, optical, acoustical, or other form of propagated signals (e.g., carrier waves, infrared signals, digital signals, etc.) etc.

Currently, it is not directly possible to determine the memory address of a descriptor in code that is written in certain programming languages, such as Fortran90. However, automatic translation programs that translate the original source code of such programs often encounter situations where they must determine the address of a descriptor during the translation process. In one embodiment, a translator for the OpenMP parallelization language must obtain the address of a descriptor when it must pass that address to a run-time library routine. In Fortran90, the intrinsic function or routine used to ascertain such an address is “LOC(x),” where ‘x’ (the argument of the intrinsic function) is the object of which the address is desired; however, inputting a descriptor as the argument of the intrinsic function LOC returns the address of the descriptor's target, not the address of the descriptor.

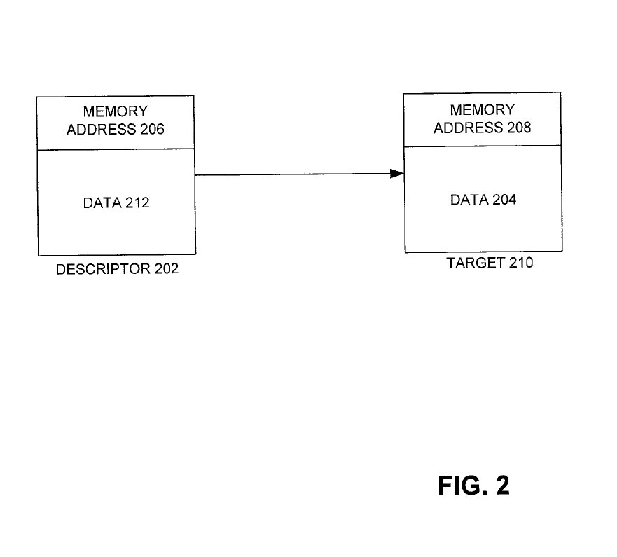

To help illustrate, FIG. 2 shows a block diagram of the relationship between descriptor 202 and target 210, according to embodiments of the present invention. In one embodiment, descriptor 202 is a fat pointer (stores data as well as the location to which it points), which stores data 212 and is stored in system 100 at memory address 206. An example of the data stored in a fat pointer, in addition to the address, is the size of the data being pointed to. In one embodiment, descriptor 202 is a simple pointer (stores only memory address 208 of target 210). Descriptor 202 points to target 210, which contains data 204 and is stored in system 100 at memory address 208.

If Fortran90 source code includes the operation “LOC(descriptor 202),” the execution of such code would return memory address 208 of target 210 instead of memory address 206 of descriptor 202. However, if Fortran90 source code includes the operation of “LOC(target 210),” the execution of such code would return memory address 208, because target 210 is not a descriptor.

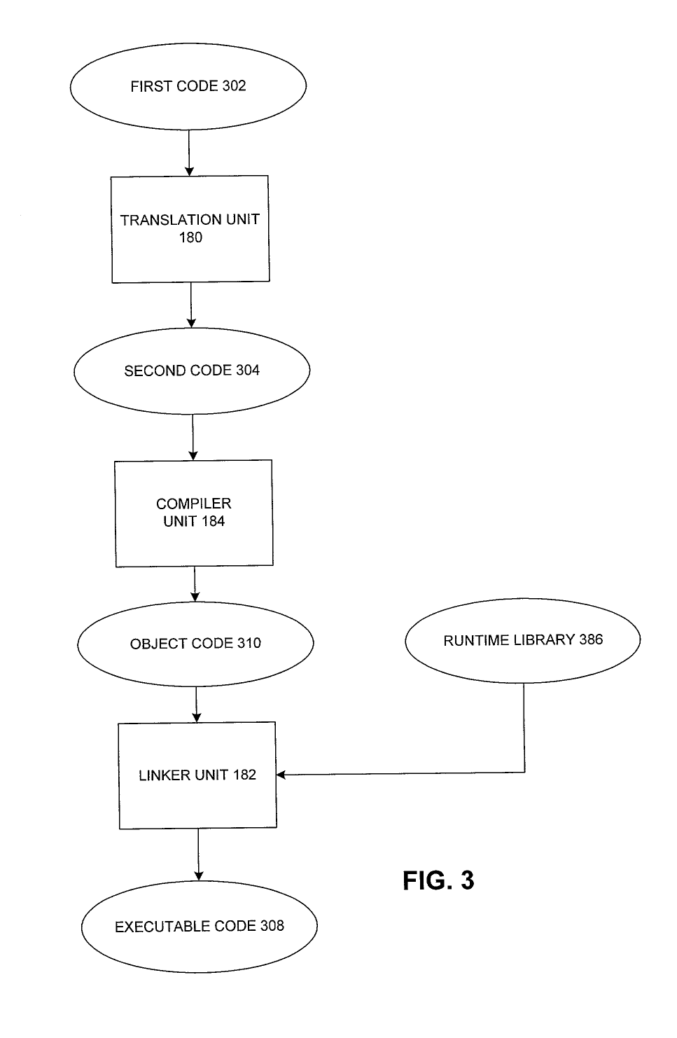

FIG. 3 illustrates a data flow diagram for generation of executable code 308, which when executed returns the memory address of a descriptor, according to embodiments of the present invention. As shown, first code 302 can include a number of program units. Examples of a program unit include a program or a module, subroutine, or function within a given program. In one embodiment, first code 302 contains OpenMP parallelization language directives in addition to Fortran90 source code.

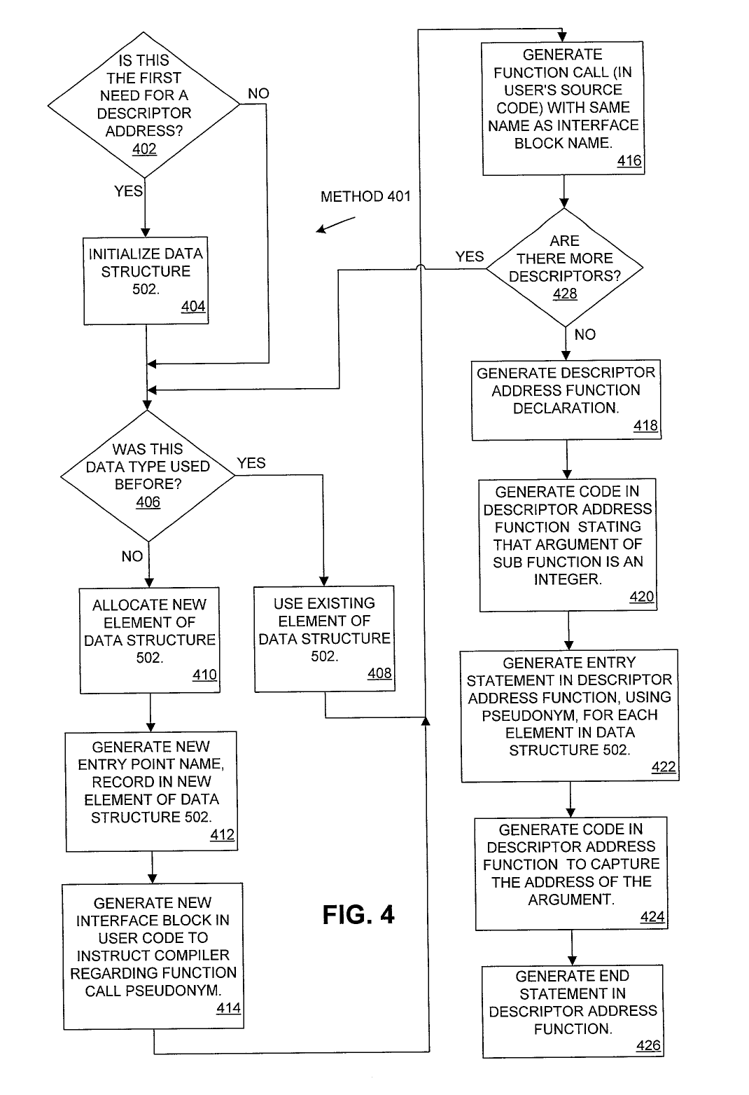

In an embodiment, translation unit 180 performs a source-to-source code level transformation of the OpenMP parallelization directives in first code 302 to generate Fortran90 source code in second code 304. However, embodiments of the present invention are not so limited. For example, in another embodiment, translation unit 180 could perform any transformation that requires passing the address of a descriptor to a library routine written in a language other than Fortran90. This transformation of first code 302 is described in more detail below in conjunction with the discussion of FIGS. 4-7.

Compiler unit 184 receives second code 304 and generates object code 310. Compiler unit 184 can be different compilers for different operating systems and/or different hardware. For example, in an embodiment, compiler unit 182 can generate object code 310 to be executed on different types of Intel® processors.

Linker unit 184 can receive object code 310 and various routines and functions from runtime library 386 and link them together to generate executable code 308. Examples of functions or routines within runtime library 386 could include, but is not limited to, LOC(X), COS(X), and DIGITS(X). In one embodiment, the routines and functions of runtime library 386 are written in a programming language that is different that the programming language of second code 304. In one embodiment, executable code 308 that is outputted from linker unit 182 can be executed in a multi-processor shared memory environment. Additionally, executable code 308 can be executed across a number of different operating system platforms, including, but not limited to, different versions of UNIX, Microsoft Windows™ , and real time operating systems such as VxWorks™ , etc.

Operation of Translation Unit 180

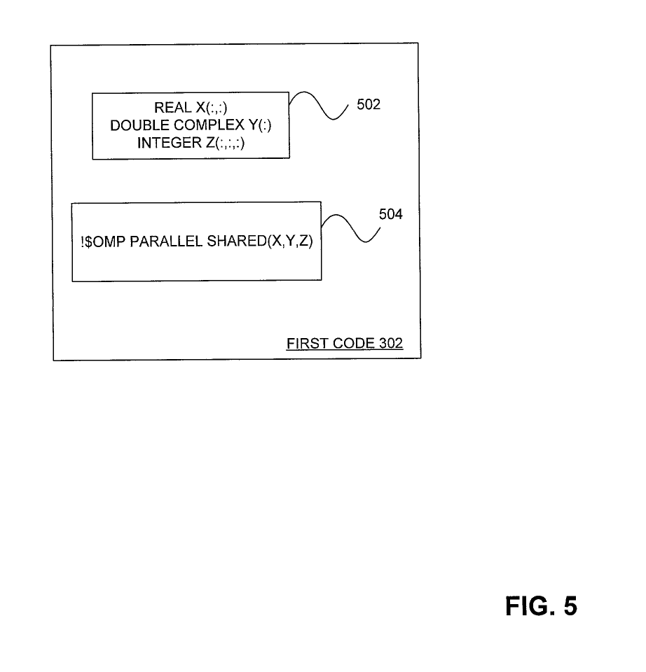

Certain operations of translation unit 180 will now be described in conjunction with the flowchart of FIG. 4. FIG. 4 illustrates a flowchart of one embodiment for the generation of code to determine memory addresses of descriptors, according to embodiments of the present invention. Method 401 of FIG. 4 commences with a check by the translation unit 180 for whether the current request for a memory address of a descriptor for a given program unit or source code is the first request for the memory address of a descriptor, at process decision block 402. To help illustrate, FIG. 5 illustrates source code that includes a number of descriptors for which the address is being obtained, according to embodiments of the present invention. In particular, FIG. 5 illustrates first code 302, which includes code segments 502 and 504, according to embodiments of the present invention. As shown in FIG. 5, in an embodiment, code segment 502 includes a number of type declaration statements that specify the properties of X, Y, and Z. In one embodiment, X, Y, and Z are descriptors, such as descriptor 202 of FIG. 2. Code segment 504 includes an OpenMP parallel directive, stating that variables X, Y, and Z should be shared in a parallel region starting at that location in the program. In order to translate that directive, the addresses of the descriptors for those variables must be passed to a runtime library routine.

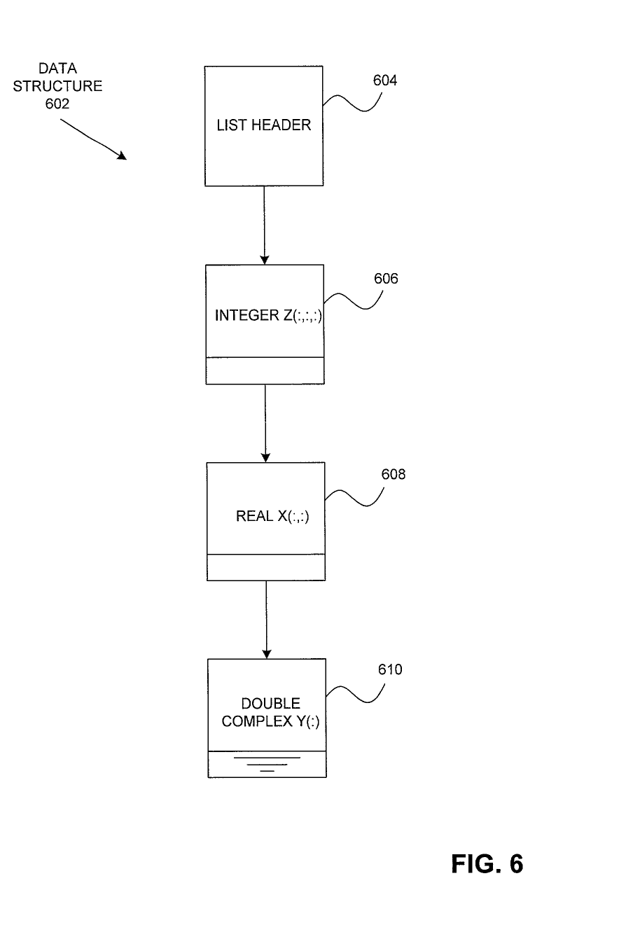

If the current request in first code 302 is the first such request, translation unit 180 creates and initializes a data structure for storing information related to the descriptors, at process block 404. To help illustrate, FIG. 6 shows a data structure for storage of descriptor information, according to embodiments of the present invention. If the current request in first code 302 is not the first such request, i.e., data structure 602 has already been created and initialized, translation unit 180 continues at process decision block 406.

In particular, FIG. 6 illustrates data structure 602, which contains an element for each distinct target data type whose descriptor address has been requested. Data structure 602 is a linked list of such elements, and wherever the descriptor address of a new, distinct data type is required, an element is added to the list.

At process decision block 406, translation unit 180 checks data structure 602 for the target data type of descriptor 202. If a previous request was executed for the memory address of a descriptor of the same target data type as descriptor 202, that target data type will already exist in data structure 602. For example, in an embodiment, at element 610, the data type “REAL X(:,:)” is stored therein; at element 608, the data type “DOUBLE COMPLEX Y(:)” is stored therein; at element 606, the data type “INTEGER Z(:,:,:)” is stored therein; at element 604, a list header exists. If the data type of target 210 is already stored in data structure 602, then the corresponding data element will be used, at process block 408, and translation unit 180 will continue at process block 416 (which is described in more detail below).

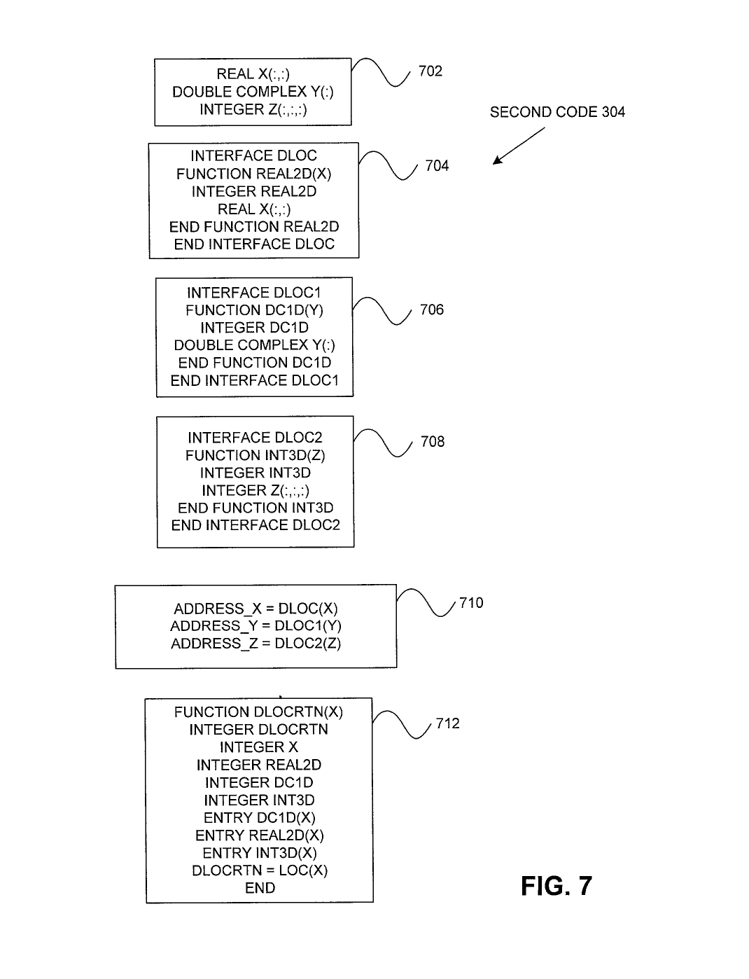

If the target data type of target 210 is not already stored in data structure 602, then translation unit 180 allocates a new element in data structure 602, e.g., element 612 (not shown), for storage of that target data type in data structure 602, at process block 410. In another embodiment, the different target data type is allocated a new location within data structure 602. At process block 412, translation unit 180 generates a new ENTRY point name and records the name in the element of data structure 602 allocated in element 612 (not shown) of data structure 602 (at process block 410). At process block 414, translation unit 180 generates a new INTERFACE block in second code 304 being generated by translation unit 180 to instruct compiler unit 184 regarding a function call pseudonym. To help illustrate, FIG. 7 shows source code being generated by translation unit 180, according to embodiments of the present invention. In particular, FIG. 7 illustrates second code 304, which includes code segments 702-712. The INTERFACE block is depicted for purposes of example at code segment 704 in FIG. 7. In one embodiment, the INTERFACE block associates the function call DLOC(X) with the function call pseudonym “REAL2D(X).” However, in other embodiments, another function name may be associated with a different function name. For example, in another embodiment, translation unit 180 generates the INTERFACE blocks at code segments 706 or 708, for different target data types DOUBLE COMPLEX Y(:) and INTEGER Z(:,:,:). In a further embodiment, translation unit 180 generates an INTERFACE block for another target data type associated with an element of data structure 602.

At process block 416, translation unit 180 generates a function call and assignment statement at code segment 710 in FIG. 7 for the target data type of descriptor 202. In one embodiment, translation unit 180 generates the source code: “Address_X=DLOC(X),” which assigns the result of the function call “DLOC(X)” to a variable “Address_X.”

However, embodiments of the present invention are not so limited, as other function calls and assignment statements may be generated for different target data types. For example, in another embodiment, translation unit 180 generates the source code: “Address_Y=DLOC1(Y),” which assigns the result of the function call “DLOC1(Y)” to a different variable, “Address_Y.” In a further embodiment, translation unit 180 generates the source code: “Address_Z=DLOC2(Z),” which assigns the result of the function call “DLOC2(Z)” to a variable “Address_Z.” However, embodiments of the present invention are not so limited, as other function calls and assignment statements may be generated for different target data types in data structure 602. Translation unit 180 continues traversing first code 302 to determine whether there are additional target data types therein, at process decision block 428. If there are more target data types, translation unit 180 returns to process decision block 406. If not, translation unit 180 continues at process block 418.

At process block 418, translation unit 180 generates a descriptor address function declaration depicted for purposes of example in the form of code segment 712 in FIG. 7. Specifically, translation unit 180 generates “FUNCTION DLOCRTN(X),” the descriptor address function declaration, (wherein “DLOCRTN” is the name of the function, and “x” is the argument thereof), in code segment 712. At process block 420, translation unit 180 generates source code at code segment 712 in FIG. 7 that instructs compiler unit 184 that the argument of the descriptor address function created is an integer, and that the return value of the function is an integer. For example, translation unit 180 generates “INTEGER DLOCRTN” and “INTEGER X” (different descriptor address function and argument designations would change the names used therein). These declarations in second code 304 cause compiler unit 184 to treat the argument of function DLOCRTN as an integer.

At process block 422, translation unit 180 generates an ENTRY statement and an INTEGER statement in the descriptor address function that corresponds to the ENTRY point name created at process block 412 (for each entry in data structure 602). In one embodiment to determine the memory address of descriptor 202, translation unit 180 generates “ENTRY REAL2D(X) and INTEGER REAL2D,” which creates an entry point named “REAL2D,” returning an integer value in the descriptor address function. Because the INTERFACE block created in process block 414 associated the REAL2D function name with the DLOC function, the use of “DLOC(X)” within second code 304 instructs compiler unit 184 to pass the descriptor for X to the entry point REAL2D, within the function DLOCRTN.

At process block 424, translation unit 180 generates source code in the descriptor address function, in code segment 712 of second code 304 in FIG. 7, to request the memory address of the argument of the description address function. In an embodiment, to determine the memory address of the argument “X,” translation unit 180 generates the source code “DLOCRTN=LOC(X),” which instructs compiler unit 184 to return the memory address of the argument “X” as the value of the function. At process block 426, translation unit 180 generates an “END” statement at code segment 712 in FIG. 7 to end the descriptor address function DLOCRTN. As illustrated, in an embodiment, a single function with different interfaces thereto allows for the returning of an address of a number of different addresses, corresponding to different target data types. However, embodiments of the present invention are not so limited. For example, in another embodiment, a separate function could be created for each different target data type or groups of target data types.

Translation unit 180 generates an INTERFACE block and a call site in second code 304 for every point in first code 302 where the memory address of a descriptor is needed (e.g., “DLOC(X)”), that instructs compiler unit 184 to pass a descriptor to an entry point (e.g., “REAL2D”) in the descriptor address function. The code generated in the descriptor address function further instructs compiler unit 184 to return the memory address of its argument, which is that same descriptor. Combined, this returns the address of the descriptor to the call site.

The chipset and processors included in the system include memories, processors, and/or Application Specific Integrated Circuits (“ASICs”). Such memory includes a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM), random access memory (RAM), magnetic disk storage media; optical storage media, flash memory devices, electrical, optical, acoustical, or other form of propagated signals (e.g., carrier waves, infrared signals, digital signals, etc.), etc.

Thus, a method and apparatus for generating source code to return the memory address of a descriptor have been described. Although the present invention has been described with reference to specific exemplary embodiments, it will be evident that various modifications and changes may be made to these embodiments without departing from the broader spirit and scope of the invention. For example, translation unit 180 could be translating a set of directives other than OpenMP. Accordingly, the specification and drawings are to be regarded in an illustrative rather than a restrictive sense.

What is claimed is:

1. A method comprising:
generating a function having an argument, the function expressed in a high-level programming language, wherein the function includes a set of one or more instructions that instruct a compiler unit to return a memory address of the argument as a result of the function; and
generating a call to the function, the call expressed in the high-level programming language, wherein the call causes the compiler unit to pass a descriptor as the argument.

2. The method of claim 1, wherein the high-level programming language includes a Fortran programming language.

3. The method of claim 1, wherein the argument is an integer data type.

4. A method comprising:
receiving a first code, wherein the first code refers to a variable of a target data type, wherein the variable is addressable using a descriptor; and
translating the first code into a second code, the second code expressed in a high-level programming language, wherein the translation requires a memory address of the descriptor, and wherein the translation comprises:
generating a function having an argument, wherein the function includes a set of one or more instructions that instruct a compiler unit to return the memory address of the argument as a result of the function; and
generating a call to the function, wherein the call causes the compiler unit to pass the descriptor as the argument.

5. The method of claim 4, wherein the translating comprises generating an interface block for the function for each different target data type in the first code.

6. The method of claim 4, wherein the high-level programming language includes a Fortran programming language.

7. The method of claim 4, wherein the argument is an integer data type.

8. The method of claim 4, further comprising generating a data structure to store information based on the target data type.

9. The method of claim 7, wherein the function includes a routine from a runtime library, the routine to return a memory address of an argument of the routine.

10. The method of claim 9, wherein the routine from the runtime library is written in a C programming language.

11. A machine-readable medium that provides instructions, which when executed by a machine, causes the machine to perform operations comprising:
generating a function having an argument, the function expressed in a high-level programming language, wherein the function includes a set of one or more instructions that instruct a compiler unit to return a memory address of the argument as a result of the function; and
generating a call to the function, the call expressed in the high-level programming language, wherein the call causes the compiler unit to pass a descriptor as the argument.

12. The machine-readable medium of claim 11, wherein the high-level programming language includes a Fortran programming language.

13. The machine-readable medium of claim 11, wherein the argument is an integer data type.

14. A machine-readable medium that provides instructions, which when executed by a machine, causes the machine to perform operations comprising:
receiving a first code, wherein the first code refers to a variable of a target data type, wherein the variable is addressable using a descriptor; and
translating the first code into a second code, the second code expressed in a high-level programming language, wherein the translation requires a memory address of the descriptor, and wherein the translation comprises:
generating a function having an argument, wherein the function includes a set of one or more instructions that instruct a compiler unit to return the memory address of the argument as a result of the function; and
generating a call to the function, wherein the call causes the compiler unit to pass the descriptor as the argument.

15. The machine-readable medium of claim 14, wherein the translating comprises generating an interface block for the function for each different target data type in the first code.

16. The machine-readable medium of claim 14, wherein the high-level programming language includes a Fortran programming language.

17. The machine-readable medium of claim 14, wherein the argument is an integer data type.

18. The machine-readable medium of claim 14, further comprising generating a data structure to store information based on the target data type.

19. The machine-readable medium of claim 14, wherein the function includes a routine from a runtime library, the routine to return a memory address of an argument of the routine.

20. The machine-readable medium of claim 19, wherein the routine from the runtime library is written in a C programming language.

21. A system comprising:
a translation unit to receive a first code that refers to a variable of a target data type, wherein the variable is referred to by a descriptor, the translation unit to translate the first code into a second code, the second code based on a high-level programming language, wherein the translation requires a memory address of the descriptor and wherein the translation comprises:
generating a function having an argument, wherein the function includes a set of one or more instructions that instruct a compiler unit to return the memory address of the argument as a result of the function; and
generating a call to the function, wherein the call causes the compiler unit to pass the descriptor as the argument;
a compiler unit coupled with the translation unit, the compiler unit to receive the second code and to generate object code, wherein the compiler unit passes the descriptor as the argument based on the call to the function.
a linker unit coupled with the compiler unit to link the object code and a number of routines to generate executable code, wherein the address of the descriptor can be retrieved through one of the number of routines when the executable code is executed.

22. The system of claim 21, wherein the generation of the second code includes the generation of a function, the function having an entity as an argument, and a call to the function, wherein the call to the function instructs a compiler unit to accept the argument as an entity for which the memory address can be determined and returned as a result of the function.

23. The system of claim 21, wherein the entity is an integer.

24. The system of claim 21, wherein the high-level programming langue includes a Fortran programming language.

25. The system of claim 21, wherein the function includes a routine from a runtime library, the routine to return a memory address of an argument of the routine.

26. The system of claim 25, wherein the routine from the runtime library is written in a C programming language.
